(19) United States
(12) Patent Application Publication
(10) Pub. No.: US 2026/0194495 A1
(43) Pub. Date: Jul. 9, 2026

(54) CONTROL DISK FOR MULTIPORT VALVE WITH IMPROVED SEALING CHARACTERISTICS, GAS ANALYZER, SIMULATING METHOD AND COMPUTER PROGRAM PRODUCT

(71) Applicant: VALMET AUTOMATION OY, Espoo (FI)

(72) Inventors: Michael FRANK, Karlsruhe (DE); Thomas NEUHAUSER, Cypress, TX (US); Josef RICHTER, Karlsruhe (DE); Piotr STRAUCH, Rülzheim (DE); Ahmad YOUSSEF, Spring, TX (US)

(73) Assignee: VALMET AUTOMATION OY, Espoo (FI)

(21) Appl. No.: 19/552,150

(22) Filed: Feb. 27, 2026

Related U.S. Application Data
(63) Continuation of application No. PCT/EP2023/073802, filed on Aug. 30, 2023.

(51) Int. Cl. G01N 30/20

(52) U.S. Cl. CPC G01N 30/20; G01N 2030/201; G01N 2030/205

(57) ABSTRACT

A control disk for a gas analyzer which includes a plurality of grooves, each having at least one fluid port, a first pair of fluid ports and a second pair of fluid ports. Each pair is configured to be sealable by a portion of a membrane. The first pair of fluid ports is arranged radially offset from the second pair of fluid ports. The invention also relates to a multiport valve for a gas analyzer that is equipped with such a control disk. Furthermore, the invention relates to a corresponding gas analyzer. Moreover, the invention relates to a method for simulating an operational behavior of such a multiport valve and a computer program product that is configured to perform such a method.

Control disk for multiport valve with improved sealing characteristics, gas analyzer, simulating method and computer program product

The present invention relates to a control disk that is suitable to be used in a multiport valve and such a multiport valve. Furthermore, the invention relates to a gas analyzer that is equipped with such a multiport valve. The invention also relates to a simulating method for such a multiport valve and a computer program product that is configured to perform such a method.

Patent application WO 2016/096423 A1 discloses a control disk for a multiport valve with a plurality of fluid ports and grooves. The plurality of fluid ports is arranged around a center of the control disk at substantially equal radial distances. The multiport valve is used in a gas chromatograph.

In various applications, gas analyzers are being used to analyze a composition of increasingly complex gas samples, which may comprise samples containing components in various compositions, for example with very low concentrations or chemically active components. Additionally, increased measurement accuracy is aspired. To these ends, multiport valves with enhanced sealing characteristics are required. It is an object of the present invention to provide a solution that offers an improvement in at least one of these outlined aspects.

That object is achieved through a control disk according to the claimed invention. The control disk is configured to be used in a multiport valve and may be a component of a gas analyzer. The control disk comprises a plurality of grooves which are configured to guide a gas flow in the plane defined by the control disk. In addition to that, the control disk comprises a plurality of fluid ports which are through-holes and allow for a gas flow substantially perpendicular to the plane defined by the control disk. The grooves are each hydraulically connected to at least one fluid port. Adjacent fluid ports, which are not directly connected through a groove, are form a first pair of fluid ports and a second pair of fluid ports respectively. Each pair of fluid ports is configured to be sealable by a portion of a membrane. With the respective portion of the membrane being in a sealing position, a gas flow from one fluid port to the other fluid port of the respective pair is inhibited. To that end, the sealing portion of the membrane may contingently cover both fluid ports of such a pair of fluid ports.

According to the present invention, the first pair of fluid ports is arranged radially offset from the second pair of fluid ports. Consequently, the first pair of fluid ports is positioned further radially outwards or inwards than the second pair of fluid ports. With pairs of fluid ports arranged in such a manner, a support surface between their respective grooves is enlarged. Having an enlarged support surface between these grooves yields an improved sealing effect. Thus, leaking gas flows from the first to the second pair of fluid ports and their respective grooves or vice versa are reduced or even inhibited. Therefore, the claimed arrangement of the pairs of fluid ports serves for minimizing a potential contamination of their respective gas flows. With reduced contamination of gas flows, a multiport valve equipped with the claimed control disk is suitable for handling gas samples whose composition is to be determined with increased precision. The radial offset may be defined based on the position of either of the fluid ports in a pair or a point between the two fluid ports of a pair.

In an embodiment of the invention, the first and second pair of fluid ports are arranged around a center of the control disk. Furthermore, the first and second pair of fluid ports may be adjacent pairs of fluid ports. The control disk may be substantially circular and the center may be the center of the circle defining the shape of the control disk. Alternatively, the control disk may have any other shape that allows for a juxtaposition of fluid ports to implement a valve actuation. The fluid ports may be arranged in substantially any annular shape, for example a rectangle, a square or an ellipse, for which a center may be defined. The first and second pair of fluid ports may have a radial offset between them which exceeds the diameter of the portion of the membrane that is utilized to actuate them as a valve. Such a design allows for using an increased portion of the available space in the plane of the control disk. Compared with control disks according to the prior art, the claimed control disk shows improved sealing characteristics and is still as compact.

In another embodiment of the claimed control disk the first and second pair of fluid ports may be arranged with a circumferential offset between each other. The circumferential offset may be defined based on the center of the control disk, as it is described above. The circumferential offset provides for an enlarged supporting surface between the pairs of fluid ports or their respective grooves. The supporting surface is to be construed as an area between the portions of the membrane which are provided for valve actuations with pressurized air or negative pressure. The supporting surface is a portion of the surface of the control disk that is to be permanently contacted by the membrane in normal operating conditions of the multiport valve that utilizes the claimed control disk. The supporting surface forms a plane contact with the membrane, thus sealing the pairs of fluid ports from each other. The enlarged supporting surface provides a more effective sealing and is less susceptible to let leaking gases through. Preferably, the circumferential offset exceeds the diameter of the portion of the membrane that is utilized to actuate one of the pairs of fluid ports. Having a circumferential offset between the first and second pair of fluid ports besides the radial offset provides another design parameter for improving the intended sealing effect. Therefore, the claimed control disk is suitable to be adapted even to demanding purposes, i.e. operation with gases with an increased leakage tendency.

The control disk may comprise a first groove on its surface which substantially forms a channel that connects to one of the fluid ports of the first pair of fluid ports. Additionally, the control disk may comprise a second groove which correspondingly connects to one of the fluid ports of the second pair of fluid ports. In that, the first groove may have a first width and the second groove may have a second with. According to the invention, the first width is greater than the second width. Such widened grooves reduce pressure restriction between entry and outlet of the valve and allow for lowering the pressure drop of the gas guided through the valve. When the control disk is used in a multiport valve that is connected to a separating column, the obtainable separation performance is increased. Especially when complex gas samples with many components are to be separated, such a reduced pressure drop is beneficial. Additionally or alternatively, at least one of the first and second groove many have a variable width. A groove width that increases along the direction of the gas flow guided in it will also reduce a pressure drop there. Thus, the claimed control disk allows for adapting a groove geometry to accommodate a gas flow that is not to be subjected to pressure drops.

The at least one surface of the claimed control disk may at in part be a super-finished surface, an electro-polished surface, a honed surface or a lapped surface. That surface may have a surface roughness R_{A}, R_{Z}, of up to 2.0 μm. Such manufacturing techniques allow for manufacturing a smooth surface that will adhere to a contacting membrane. Furthermore, these manufacturing techniques allow for keeping the control surface level, i.e. without warping deformations and offer a high degree of process reliability. That also results in an improved sealing effect between the control disk and a membrane.

In yet another embodiment of the present invention, the control disk comprises a purge channel that is configured for flushing contaminants or remaining gas leakages within the multiport valve with a gas flow. The purge channel may be formed as a groove in the control disk and it may pass through a portion of the control disk where contamination may occur or shall be proactively avoided. The contaminants may enter the multiport valve with a carrier gas or the gas sample that is to be analyzed or diffuse from the ambient of the multiport valve. The purge channel is configured to guide a gas flow that sweeps away the contaminants or remaining internal leakages between grooves. The contaminants may be flushed downstream on the purge channel and guided out of the control disk or the multiport valve. Even though such purge channels locally reduce the sealing effect between the control disk and the membrane, there is still sufficient cohesion between them to implement a purge channel.

An aggregation of contaminants between the control disk and the membrane may be reduced or even be avoided in an active manner. The flushing of the purge channel may be performed based on a control program of the multiport valve. As a result, lifetime of the multiport valve is prolonged. The gas flow in the purge channel may be the carrier gas, which is easily available in sufficient quality. Thus, the claimed control disk is robust and offers an extended useful product life. The purge channel may be manufactured by engraving the control disk. Therefore, the purge channel may have small dimensions and may be implemented in a variety of control disk designs. The consumption of purging gas used for purging is relatively low due to the small dimensions.

In the claimed control disk, at least one of the grooves and/or one of the fluid ports may be manufactured through at least one of laser-based cutting, laser-based milling, laser-based engraving or any other suitable manufacturing technique, for example etching. These manufacturing techniques allow for high precision and minimizing burr or sharp edges. Burr and sharp edges may impair how smoothly the membrane can cover the control disk. In the vicinity of such a sharp edge or burr, the cohesion between the membrane and the control disk will be reduced. Consequently, such laser-based manufacturing techniques reliably provide for a control disk geometry that fully exploits the technical potential of the materials used for the control disk and the membrane. Moreover, such manufacturing techniques allow for widely automated manufacturing, thus making the claimed control disk relatively cheap to produce.

The object of the invention is also achieved with a claimed multiport valve. The multiport valve is configured to be used in a gas analyzer and comprises a first and a second base component. The base components may substantially be metal blocks, each with a plurality of ports for connecting gas supply containers, gas drainage containers and/or throttle elements. The multiport valve also comprises at least one membrane and a control disk which are held between the first and second base component. The membrane is arranged and configured to be actuated by pressurized air or negative pressure so that it acts as a valve with the control disk. Such an actuation is to be construed as an actuation of the multiport valve as such. The multiport valve may have the same basic functioning as a multiport valve according to WO 2016/096423A1. The contents of WO 2016/096423 A1 are hereby incorporated into the present application by reference. Pursuant to the invention, the control disk is embodied according to one of the examples outlined above. Such a control disk shows a tight sealing with the membrane and minimizes gas leakages in the plane defined by the surface of the control disk. This allows for minimizing or avoiding a contamination of a carrier gas with a gas sample, which would incur so-called “ghost peaks” in chromatograms or other imprecisions. In addition to that, also ambient gas intrusion in the gas sample is avoided. For chemically active components in the gas sample any potential reaction with ambient gases of moisture is avoided. When silanes are guided through the multiport valve, a mixture with moisture may cause reaction which forms sand. Such sand would cause excessive wear in the multiport valve. Therefore, the claimed control disk allows for an improved handling of several types of gas samples, especially such ones containing silanes. Consequently, the claimed multiport valve allows for precise chromatographic measurements. The lifetime of the multiport valve in prolonged. Furthermore, the claimed multiport valve may have dimensions compatible with multiport valves according to the prior art or even identical ones and could substitute them. Thus, an existing gas analyzer may be upgraded by substituting its multiport valve. Such an upgraded gas analyzer will be suitable to analyze a broader range of gas samples which require enhanced measurement precision. The features of the control disk apply to the claimed multiport valve equally and may be construed to features of the multiport valve as such, too.

In an embodiment of the invention, a first pair of fluid ports is configured to regulate a flow of a gas sample that is to be analyzed. Furthermore, a second pair of fluid ports is configured to regulate a flow of the carrier gas or a gas mixture that comprises the carrier gas. In several gas analyzers, the quantity of carrier gas may significantly exceed the amount of the gas sample that is to be examined, for example in trace analysis.

Even minimal leakages of carrier gas into the gas sample may contaminate the gas sample and render it useless for the intended analysis or distort the measurement of its components. In addition to that, also leakages of the sample into the grooves for carrier gas may be avoided, which could result in wrong readings.

Furthermore, the at least one of the first or second base component comprises a bore that is configured to apply a force that is exerted by pressurized air. The force exerted by the pressurized air may press one of the membranes against the claimed control disk, which may occlude, i.e seal, at least one of a fluid port or a groove on the surface of the control disk. Alternatively, the bore on may be configured to apply a tractive force through negative pressure. With such negative pressure, one of the membranes may be pulled away from the control disk thus clear at least one of a fluid port or a groove on the surface of the control disk. Both based on pressurized air and negative pressure, the control disk may be used to actuate the multiport valve which utilizes the claimed control disk. Bores may be manufactured easily with enhanced precision and only require reduced dimensions to allow for a safe actuation. Therefore, a first and a second base component with a plurality of bores may be manufactured easily. In turn, even complex base components may be manufactured which offer a broad scope of functions for the multiport valve. The obtainable scope of complexity is only limited by the amount of available space on the surfaces of the first and second base component and the control disk's size. The claimed multiport valve may be configured to serve even in complex applications, for example gas analyzers.

Still further, the claimed multiport valve comprises multiple purge channels, each of them being configured to purge separate portions of the control disk or the multiport valve. At least one of the purge channels may be connected to a source of carrier gas and a gas exhaust. The purge channels may have limited dimensions which cause pressure restrictions and allows for purging the multiport valve without significant increases of carrier gas consumption. Any planar intrusions into the multiport valve from the ambient into a groove or a fluid port may be flushed out to the gas exhaust. Thus, the negative effects of such intrusions may be mitigated or even be avoided.

The underlying object of the invention is also achieved through a claimed gas analyzer. The gas analyzer comprises a multiport valve that is connected to a carrier gas receptacle and a feed system for a gas sample that is to be analyzed. Particularly, the composition of the gas sample and the concentrations of its components may be determined when the gas sample is analyzed. Furthermore, the gas analyzer comprises a detector that is directly or indirectly connected to the multiport valve. The detector is also connected to an evaluating unit which is configured to detect and quantify at least one component of the gas sample. According to the present invention, the multiport valve is a multiport valve pursuant to one of the previously described embodiments. With such a multiport valve, the gas analyzer is less prone to carrier gas leakages within the multiport valve and therefore less susceptible to contaminations of gas samples with carrier gas. Having fewer and less contaminated gas samples allows for a more precise determination of its composition. For example, measurements oriented on purity analysis of gases may be improved by that. The claimed gas analyzer may be utilized to monitor the composition of an outgoing hydrogen stream of an electrolyzer, an ingoing hydrogen stream of a fuel cell or be used for trace analysis. Alternatively, the claimed gas analyzer may be a gas chromatograph.

Moreover, the object outlined above is also achieved by the claimed method for simulating an operational behavior of a multiport valve in a gas analyzer. In context with the claimed method, the terms “gas analyzer” and “simulated gas analyzer” may be construed as being interchangeable. The operational behavior may comprise the progression of a gas sample or carrier gas through the multiport valve and their respective thermodynamic variables, e.g. temperature, density, pressure, flow speed, heat energy and/or enthalpy. It may also comprise their leakage behavior at a sealing. The method comprises a first step during which a set of data points is provided. The set of data points mirror the functioning of at least a portion of the multiport valve that is to be simulated. The data points may mirror the design of the respective portion of the multiport valve or the entire multiport valve. Particularly, the set of data points may constitute a so-called digital twin or may be part of a digital twin. The expression digital twin is to be construed in accordance with the document US 2017/286572A1. The contents of US 2017/286572 A1 are incorporated into this patent application by reference. The set of data points may be provided by loading them into a memory of a computer on which the claimed method may be performed.

The claimed method also comprises a second step in which at least one operational parameter of the multiport valve is set. The operational parameter may comprise a condition under which the multiport valve is operated, e.g. an ambient temperature. Additionally or alternatively, the operational parameter may comprise an information about the analysis process that is to be simulated, e.g. which gas samples and in which amounts are to be utilized, their pressures, temperatures and/or flow rates at which they are provided, and/or the duration of the operation. The second step may be performed by a user and/or through a data interface.

In addition to that, the claimed method comprises a third step in which a computer program product is executed. That computer program product is configured to emulate the operational behavior of the multiport valve based on the set of data points provided in the first step. The operational behavior is also emulated based on the at least one operational parameter provided in the second step. The set of data points and the operational parameter may be combined by the computer program product which emulates the operation, i.e. the operational behavior, of the multiport valve under the circumstances defined in the first and second step. That emulated operation is also to be construed as a simulated operation. That serves for determining at least one performance parameter of the multiport valve. The performance parameter describes an information about events during the simulated operation which are yielded through the simulated operation of the simulated multiport valve. For example, the performance parameter may comprise thermodynamic quantities like the temperature, density and/or flow rate of a gas sample or a carrier gas that exits a component of the simulated multiport valve and/or a leakage behavior that mirrors a quantity of the carrier gas that contaminates a subsequent gas sample and how it affects its composition.

In a fourth step, the at least one performance parameter is output to a user and/or a data interface. The fourth step may utilize a suitable data connection to an output device readable by the user and/or to a different computer platform that may be configured to process the at least one performance parameter further. According to the present invention, the multiport valve simulated through the claimed method is a multiport valve according to one of the embodiments outlined above. The features of the claimed multiport valve also apply to the claimed method in a corresponding manner. Thus, the features of the claimed multiport valve also confer to the claimed method.

The claimed multiport valve shows a reduced propensity for leakages between different pairs of fluid ports and grooves. The multiport valve comprises a control disk in which a first and a second pair of fluid ports are radially offset from each other, thus extending the supporting surface between them. That minimizes the contamination of a gas sample during operation of the multiport valve to a degree that allows for neglecting it during simulation or for simulating it in a simplified manner. The areas between such pairs of fluid ports may be simulated as hydraulic components with excessive drag coefficients, thus rendering the contamination of a gas sample negligible. Alternatively, a contamination of a gas sample may be assumed to be non-existent. In both cases, complex CFD calculations that mirror the flow dynamics inside the multiport valve may be avoided. That in turn allows for an accelerated simulation of the operational behavior of the multiport valve. The claimed method may be executed to show real-time characteristics, thus allowing to monitor the condition of a corresponding physical multiport valve. Furthermore, a plurality of such multiport valves may be simulated with acceptable demand for computing capacity. Based on the claimed method, a complex gas analyzer or gas analyzer system with several multiport valves may be monitored closely and abnormal operational states may be detected early. With such a monitoring system, a gas analyzer equipped with the simulated multiport valve may be safely used with carrier gases like hydrogen which may form explosive gas mixtures with air.

The object described in the present application is also achieved through the claimed computer program product. The claimed computer program product is configured to simulate an operational behavior of a multiport valve. Consequently, the computer program product may comprise code and/or instruction that make a computer perform the simulation of the operational behavior of the multiport valve. According to the present invention, the operational behavior is simulated through a method according to one of the embodiments described above. The computer program product may comprise a set of data points that at least partly mirror the gas analyzer that is to be simulated. The computer program product may be a so-called digital twin, as it is described in US 2017/286572A1. Furthermore, the computer program product may be stored in a machine-readable medium that is configured to interact with a computer. The claimed computer program product may be embodied as software or in a hardwired form, e.g. a chip, an ASIC or an FPGA, or as a combination of software and a hardwired form. Furthermore, the computer program product may be embodied as a monolithic program that is executed on a single hardware platform. Alternatively, the computer program product may be embodied as a modular software, comprising partial programs that are executed on separate hardware platforms and which interact with each other over a suitable data connection, e.g. an ethernet connection, an internet connection or a mobile data service.

In the following, the present invention will be described in more detail in several figures. The figures are to be construed as mutually complementary. Particularly, identical numerals are to be construed as having the same technical meaning. The features of the embodiments shown in the figures may be combined with each other. Additionally, the features of the embodiments shown in the figures may also be combined with the embodiments outlined above. In particular, the figures show:

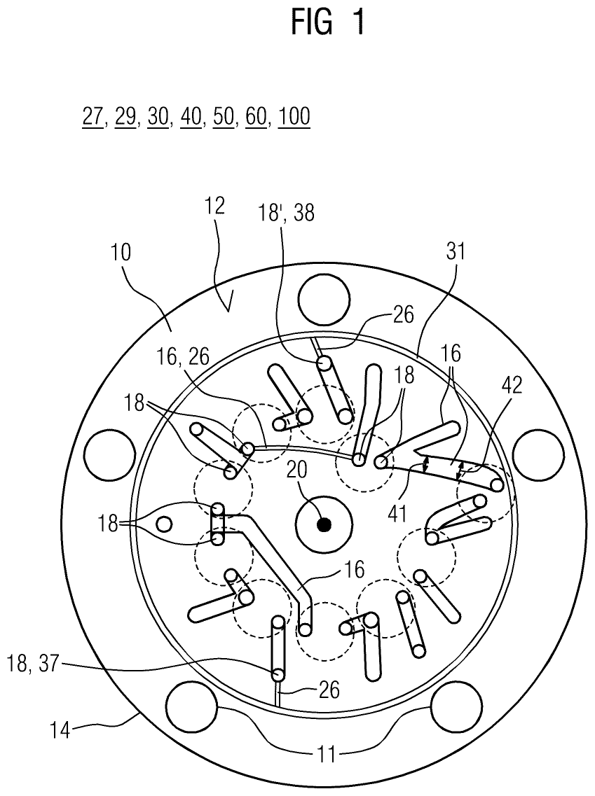

FIG. 1 a top view of a first embodiment of the claimed control disk;

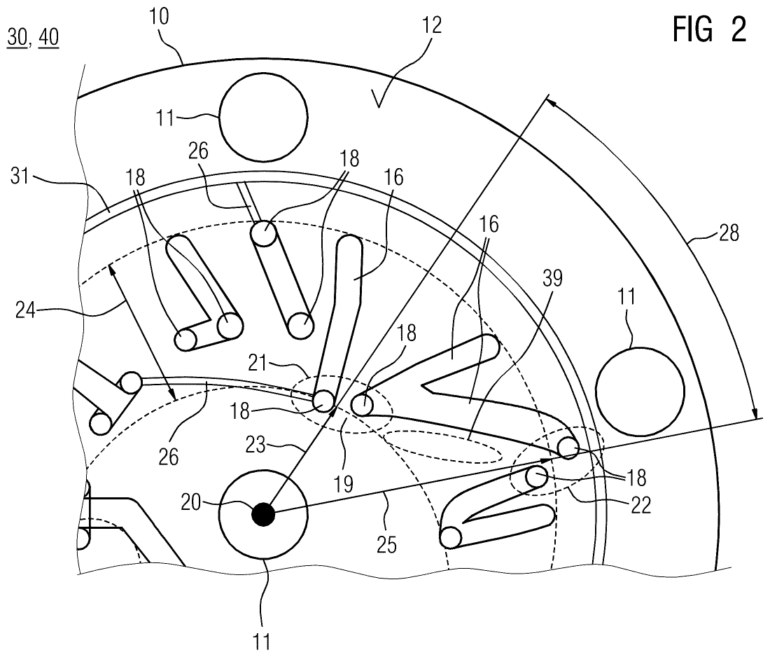

FIG. 2 a section of the first embodiment of the claimed control disk;

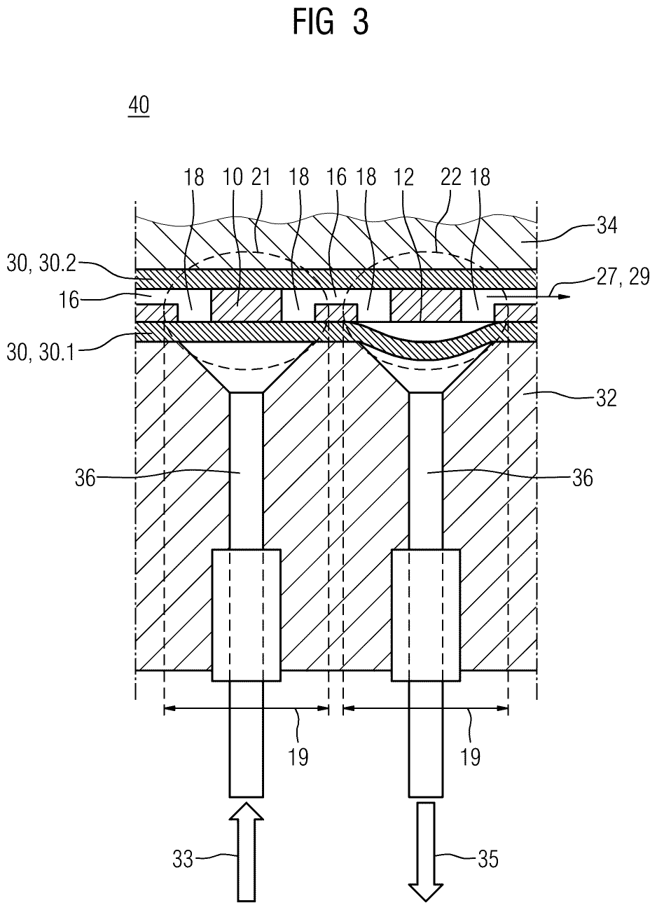

FIG. 3 a cross section of an embodiment of the claimed multiport valve;

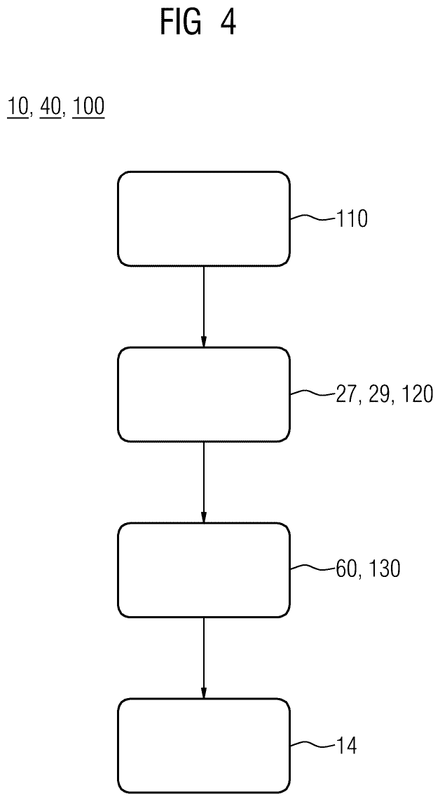

FIG. 4 a schematic overview of an embodiment of a claimed simulating method.

FIG. 1 shows a top view of a first embodiment of the claimed control disk 10, which is configured to be used in a multiport valve 40. The control disk 10 has a basically circular shape with a center 20. At the center 20 and arranged around the center 20 are assembly holes 11 which allow for mounting and aligning the control disk 10 in the multiport valve 40. The control disk 10 is manufactured from a metal or an alloy and has a surface 12 which is at least partially super-finished, honed or lapped. The flipside 14 of the control disk 10 may also be at least partially a super-finished surface, a honed surface or a lapped surface. Furthermore, the control disk 10 comprises fluid ports 18 which are through-holes that extend from the surface 12 to the flipside 14 of the control disk. The fluid ports 18 are arranged in pair with each fluid port 18 being connected to a different groove 16. The grooves 16 may be manufactured through laser-based cutting, laser-based milling, laser-based engraving or etching and allow for the flow of a gas sample 29 or a carrier gas 27 which are to be guided by the control disk 10 during an operation of the multiport valve 40. To that end, at least one of the surface 12 or the flipside 14 of the control disk 10 may be covered by a membrane 30 not shown in FIG. 1. Furthermore, one of the grooves 16 has a portion with a first width 41 and a portion with a second width 42. The second width 42 is smaller than the first width 41, thus giving the groove 16 a variable width. With such a variable width, a pressure drop in the groove 16 may be minimized. Pairs of fluid ports 18 are controllably occluded, i.e. sealed, and cleared by the membrane 30 in the vicinity of a pair of fluid ports 18, thus allowing for controllable a gas flow between them. With the surface 12 at least partially being super-finished, honed or lapped and the grooves 16 being manufactured by laser, the edges of the grooves 16 are smooth. Thus, a membrane 30 that covers the surface 12 of the control disk 10 forms a tight sealing. The fluid ports 18 are arranged in a basically circular shape around the center 20. Furthermore, the control disk 10 comprises a groove 16 that forms a purge channel 26. The purge channel 26 is configured cause a gas flow, for example a flow of carrier gas, purges an area between two fluid ports 18. The purge channel 26 allows for purging the fluid ports 18 it connects. Additionally, the control disk 10 also comprises an annular purge channel 31 that envelops the fluid ports 18 and the grooves 16 which connect them. The annular purge channel 31 serve for purging around the control disk 10. The annular purge channel 31 is connected to one fluid port 18 which serves a gas inlet 37 and another fluid port 18 which serves as a gas exhaust 38. Both the gas inlet 37 and the gas exhaust are each connected to the annular purge channel 31 by a purge channel 26. With such a gas flow, pockets of contaminations between the control disk 10 and the membrane 30 covering the surface 12 may be flushed out. In addition to that, the control disk 10 is at least partly mirrored in a set of data points which belong to a computer program product 60 that is configured to perform a method 100 for simulating the operational behavior of the multiport valve 40 that utilizes the control disk 10.

A section of the first embodiment of the claimed control disk 10, as depicted in FIG. 1, is shown in FIG. 2. The control disk 10 comprises fluid ports 18 which are arranged in pairs. Both a first pair 21 and a second pair 22 of fluid ports 18 each comprise two fluid ports 18 which are arranged adjacent to each other. The first pair 21 of fluid ports 18 is positioned at a first radial distance 23 to the center 20 of the control disk 10. The second pair 22 is positioned at a second radial distance 25 from the center 20. The radial distances 23, 25 are each defined by a center point of the respective pairs 27, 29. Consequently, there is a radial offset 24 between the first and second pair 21, 22 of fluid ports 18. In addition to that, there is also a circumferential offset 28 between the first and second pair 21, 22 of fluid ports 18. The circumferential offset 28 is defined by the same references as the radial offset 24. In the respective vicinity of the first and second pair 21, 22 of fluid ports 18, an actuation area 19 is defined where the membrane 30 that covers the surface 12 of the control disk 10 may be pulled away from the control disk 10 or be pressed against the control disk 10. During a normal operation of the multiport valve 40, the membrane 30 stays in contact with the control disk 10 outside of the actuation areas 19. With the first and second pair 21, 22 of fluid ports 18 spaced apart in both a radial and a circumferential direction, an area between the actuation areas 19 is extended. The area between the actuation areas 19 is a portion of the surface 12 forms a supporting surface 39 which inhibits or prevents a gas flow. With such an extended supporting surface 39, the sealing effect there is enhanced both by the extended distance between the first and second pair 21, 22 of fluid ports 18 and its extended area that tightly sticks to the membrane 30. For example, a portion of carrier gas 29 at the first pair 21 of fluid ports 18 is prevented from flow to the second pair 22 of fluid ports 18, where a gas sample 29 resides at the same time. Therefore, a propagation of a contamination from one actuation area 39 to another is minimized or eliminated. As a result, the control disk 10 allows for maintaining a high measurement precision in a gas analyzer 50 in which the multiport valve 40 with the control disk 10 is utilized. Thus, the control disk 10 is especially suitable for handling gas samples 29 or carrier gasses 27 which comprise hydrogen or other gasses which may form inflammable gas mixtures. Furthermore, the surface 12 of the control disk 10 comprises an annular purge channel 31. The fluid ports 18 are arranged inside the area defined by the annular purge channel 31, which is configured to supply a carrier gas 27 for flushing out contaminants from fluid ports 18 connected to them. One of the fluid ports 18 of the first pair 21 is connected to another fluid port 18 through a purge channel 26. Another purge channel 26 extends from yet another fluid port 18 to the annular purge channel 31. The purge channels 26 are each directly or indirectly connected to the annular purge channel 31, which form an integrated purging system. Both the purge channels 26 and the annular purge channel 31 are formed through a laser-based manufacturing technique and are narrower than the grooves 16 between the fluid ports 18. At least the control disk 10 is mirrored in a set of data points that is part of a computer program product 60 that is configured to simulate an operational behavior of a multiport valve 40 that comprises the control disk 10 shown in FIG. 1 and FIG. 2. To that end, the computer program product 60 is configured to perform a simulation method 100 not shown in FIG. 2.

FIG. 3 shows a cross section of a portion of an embodiment of a multiport valve 40. The multiport valve 40 is configured to utilize a control disk 10 which may be embodied according to FIG. 1 and FIG. 2. The multiport valve 40 comprises a first base component 32 and a second base component 34 with form the main support structure of the multiport valve 40. A control disk 10 and two membranes 30 are accommodated between the first and second base component 32, 34. The control disk 10 is covered by a first membrane 30.1 on a side facing the first base component 32 and by a second membrane 30.2 facing the second base component 34. The control disk 10 comprises fluid ports 18 and grooves 16 which allow for guiding a gas flow, which may be a carrier gas 27 or a gas sample 29. The gas flow basically flows in the plane that is defined by the control disk 10, which is horizontal in FIG. 3. The fluid ports 18 form a first pair 21 and a second pair 22, each pair 21, 22 being surrounded by an actuation area 19. In the actuation area 19, the first membrane 30.1 may be pressed against the control disk 10 through pressurized air 33 that is guided by a bore 36 in the first base component 32. Alternatively, the first membrane 30.1 may be pulled away from the control disk 10 through negative pressure 35 that is guided to the first membrane 30.1 through a bore 36 in the first base component 32. Since the first and second pair 21, 22 of fluid ports 18 are arranged radially offset, a supporting surface 39 between them is extended. The surface 12 of the control disk 10 is a super-finished, honed or lapped surface and forms a tight sealing with the first membrane 30.1, which is made of an elastic material like an elastomer or rubber. That prevents a propagation of contaminants between the first and second pair 21, 22 of fluid ports 18. The actuation of the multiport valve 40 and a gas leakage behavior in the supporting surface 39 as shown in FIG. 3 is part of the operational behavior that is simulated by a computer program product 60. The computer program product 60 is configured to perform a simulation method 100 that is not shown in FIG. 3.

FIG. 4 shows an embodiment of a claimed method 100 that is configured to simulate an operational behavior of a multiport valve 40. Such a multiport valve 40 may be embodied according to FIG. 3 and may comprise a control disk 10 pursuant to FIGS. 1 and 2. In context with the claimed method 100, the terms “multiport valve” and “simulated multiport valve” are to be construed to be interchangeable. The method 100 comprises a first step 110 in which a set of data points is provided, that mirrors the functioning of at least a portion of the multiport valve 40 which is to be simulated. The data points may be a part of a digital model or a so-called digital twin. In a subsequent second step 120 of the method 100, at least one operational parameter is set. The operational parameter defines the operational behavior that is to be simulated. The operational parameter may be at least one of a pressure of a gas sample 29 or a carrier gas 27, information about its respective composition, a flow speed, an actuation pattern of the multiport valve 40. The operational parameter at least partially defines a situation that is to be simulated based on the method 100. In addition to that, the method 100 comprises a subsequent third step 130, in which a computer program product 60 is executed. That computer program product 60 is configured to emulate to operational behavior of the multiport valve 40. The emulation of the operational behavior is based on the set of data points entered during the first step 110 and the operational parameter entered during the second step 120. During the third step 130, the computer program product 60 determines at least one performance parameter of the multiport valve 40. The performance parameter may be a predicted amount of contamination of a gas flow in the multiport valve 40. To that end, the computer program product 60 is embodied as a digital twin of at least a portion of the multiport valve 40. Furthermore, the method 100 shown in FIG. 3 comprises a subsequent fourth step 140, in which the performance parameter determined in the third step 300 is output to at least one of a user or a data interface. The multiport valve 40, that is simulated through the method 100 shown in FIG. 4 is a multiport valve 40 according to one of the embodiments outlined above.

1. A control disk for a gas analyzer, comprising a plurality of grooves, each having a least one fluid port, a first pair of fluid ports and a second pair of fluid ports, each being configured to be sealable by a portion of a membrane, wherein the first pair of fluid ports is arranged radially offset from the second pair of fluid ports.

2. The control disk according to claim 1, wherein the first and second pair of fluid ports are arranged around a center of the control disk.

3. The control disk according to claim 1, wherein the first and second pair of fluid ports are arranged with a circumferential offset between each other to maximize a supporting surface between them.

4. The control disk according to claim 1, wherein a first groove connected to a fluid port of the first pair of fluid ports has a first width which is greater than a second width of a second groove connected to a fluid port of the second pair of fluid ports.

5. The control disk according to claim 1, wherein at least one surface of the control disk is at least in part a super-finished surface, a honed surface or a lapped surface.

6. The control disk according to claim 1, wherein the control disk comprises a purge channel for flushing contaminants out with a gas flow.

7. The control disk according to claim 1, wherein at least one of the grooves and/or one of the fluid ports is manufactured through at least one of laser-based cutting, laser-based milling, laser-based engraving or etching.

8. A multiport valve for a gas analyzer, comprising a first and a second base component, at least one membrane and a control disk which are positioned between the first and second base component for actuating the multiport valve with pressurized air or negative pressure, wherein the control disk is embodied according to claim 1.

9. The multiport valve according to claim 8 wherein the first pair of fluid ports is configured to regulate a flow of a gas sample that is to be analyzed and that the second pair of fluid ports is configured to regulate a flow of a carrier gas or a gas mixture comprising the carrier gas.

10. The multiport valve according to claim 8, wherein the at least one of the first or second base component comprises a bore that is configured to apply a force exerted by pressurized air or negative pressure.

11. The multiport valve according to claim 1, wherein it is configured to flush the purge channel with the carrier gas.

12. A gas analyzer, comprising a multiport valve that is connected to a carrier gas receptacle and a feed system for a gas sample to be analyzed and a detector, the detector being connected to an evaluating unit, wherein the multiport valve is embodied according to claim 1.

13. A method for simulating an operational behavior of a multiport valve in a gas analyzer, comprising the steps:
a) providing a set of data points that mirror the functioning of at least a portion of the multiport valve that is to be simulated;
b) setting at least one operational parameter that defines the operational behavior that is to be simulated;
c) executing a computer program product that is configured to emulate the operational behavior of the multiport valve based on the set of data points combined with the as least one operational parameter to determine at least one performance parameter;
d) outputting the at least one performance parameter to at least one of a user or a data interface;
wherein the multiport valve is embodied according to claim 1.

14. A computer program product for simulating an operational behavior of a multiport valve, wherein the operational behavior is simulated through a method according to claim 13.
